(19) United States
(12) Patent Application Publication
(10) Pub. No.: US 2008/0059208 A1
(43) Pub. Date: Mar. 6, 2008

(54) System and Method for Evaluation, Management, and Measurement of Sponsorship

(76) Inventors: Mark Rockfeller, New York, NY (US); Kenneth Bremer, Pearl River, NY (US); Thomas Crowe, Bronx, NY (US)

Correspondence Address: THELEN REID BROWN RAYSMAN & STEINER LLP, PO BOX 1510, NEW YORK, NY, 10150-1510, US

(21) Appl. No.: 11/469,849

(22) Filed: Sep. 1, 2006

(51) Int. Cl. G06Q 10/00; G06Q 30/00; G06F 15/02; G06F 9/46

(52) U.S. Cl. 705/1; 705/9

(57) ABSTRACT

The present invention is directed to systems and methods for automated evaluation of sponsorship proposals, management of active sponsorship programs and measurement of the performance of the sponsorship programs. The system provides a desktop application server, which facilitates communication with sponsor users, and a portal application server, which facilitates communication with property users. The portal application server facilitates collection of the sponsorship proposal information from the property users. The desktop application server provides a plurality of web applications that facilitate objectives alignment of the sponsorship proposals, scoring and evaluation of the sponsorship proposals, management of the leverage and activation of the sponsorship assets, as well as applications for cost/value measurement of the sponsorship programs, subjective measurements of their performance and measurement of the return-on-objective of the sponsorship programs.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records but otherwise reserves all copyright rights whatsoever.

### FIELD OF THE INVENTION

The present invention relates generally to the field of sponsorship and particularly to systems and methods for evaluation of sponsorship proposals, management of sponsorship assets, and measurement of sponsorship performance.

### BACKGROUND OF THE INVENTION

Sponsorship commonly refers to support of an event, activity, person, or organization, financially or through the provision of products, and is a popular tool for promotion, publicity, and audience expansion. For example, a corporation, seeking to improve brand recognition, may equip a famous athlete or sports team, who then conspicuously uses the branded gear. The sponsor benefits from both the exposure to the audience or users of the sponsored property and the association with the property that is being sponsored. The property owner, conversely, benefits financially from direct payments, a reduced need to buy goods and services, or both.

A property owner commonly initiates a sponsorship by submitting a sponsorship proposal to a potential sponsor. Based on this proposal, the potential sponsor then decides whether the opportunity merits the organization's participation. Many factors affect the potential sponsor's decision, such as the kind of property sponsored, the demographics and size of the intended audience, and the cost, among many other things.

The decision can be complex, especially for large enterprises, such as multinational banks, which receive many sponsorship proposals that may come from different regions of the world. One reason is that proposals are often submitted in varying languages and formats. Another is that proposals are often considered by different individuals, who must consider various factors specific to the geography, culture, economy, and demographics of the region from where the sponsorship is solicited. These same considerations can also tremendously complicate attempts to measure the effectiveness of any given sponsorship program.

Accordingly, there is a need to provide an effective mechanism to evaluate sponsorship proposals and to measure the effects of sponsorship.

### SUMMARY OF THE INVENTION

Embodiments of the present invention are directed to Internet-based systems and methods for management of sponsorship programs and particularly to mechanisms for evaluation of sponsorship proposals and sponsorship performance measurement.

Embodiments of the invention provide systems and methods by which representatives of entities seeking sponsorship may submit proposals to potential sponsors. Automated systems, configured to reflect the goals and capabilities of the potential sponsor, process submitted proposals, solicit information regarding the proposal and the proposed recipient of the sponsorship, and sort potential sponsorship opportunities for further review by the appropriate persons connected with the potential sponsor. Such sorting may, e.g., measure the match between the sponsorship opportunity and the potential sponsor's goals. An embodiment of the invention may aid the management of a workflow for evaluating incoming sponsorship opportunities.

Thus, in an embodiment of the invention, a sponsorship management system is provided, comprising a portal application server operative to collect sponsorship proposal information from a property user, wherein the sponsorship proposal information comprises property user information and property information; a database server operative to store the collected sponsorship proposal information in one or more data stores; and a desktop application server comprising one or more software modules operative to facilitate one or more of evaluation of sponsorship proposals, management of sponsorship assets and measurement of sponsorship performance.

In an embodiment of the invention, the desktop application server further comprises a web application framework that facilitates execution of the one or more software modules. In such an embodiment, the web application framework may provide a database interface that facilitates data communication between the one or more software modules and the database server. In another such embodiment, the web application framework may provide a user authentication module that facilitates sponsor user access to the sponsorship proposal information. Such an alternative embodiment of the invention may also provide a role-based access to the sponsorship proposal information, whereby sponsor users with different roles have different access permissions to the sponsorship proposal information.

In another embodiment of the invention, the desktop application server comprises an objectives alignment module operative to determine the degree of fitness of the sponsorship proposal with one or more strategic sponsorship objectives specified by a sponsor user. The strategic sponsorship objectives may, depending on the embodiment, comprise one or more of marketing objectives, target demographic objectives and brand attribute objectives.

In an embodiment of the invention, the desktop application server comprises a scoring and evaluation module operative to provide one or more of objective evaluation of sponsorship proposals and subjective evaluation of sponsorship proposals. In such an embodiment, to facilitate objective evaluation of the sponsorship proposals, the scoring and evaluation module may automatically evaluate a sponsorship proposal against one or more sponsor user specified sponsorship criteria. Depending on the embodiment of the invention, such sponsorship criteria may comprise one or more of a type of the sponsorship property, fitness of the sponsorship property and the sponsor's brand, and the geographic market exposure of the sponsorship. The scoring and evaluation module may also automatically reject the sponsorship proposal if the sponsorship proposal does not meet one or more sponsorship criteria.

In an embodiment of the invention, to facilitate subjective evaluation of the sponsorship proposals, the scoring and evaluation module may provide to the sponsor user one or more questions that solicit the sponsor user's opinion about the sponsorship proposal. In such an embodiment, the scoring and evaluation module may provide to the sponsor user one or more sample answers to one or more provided questions, wherein one or more provided answers have numeric values assigned thereto. Further, in such an embodiment, the scoring and evaluation module may compute a subjective evaluation score based on the numeric values of the answers chosen by the sponsor user in response to the one or more provided questions.

In an embodiment of the invention, the desktop application server comprises a financial valuation module operative to calculate monetary value of one or more sponsorship assets. In such an embodiment, the desktop application server may comprise a leverage and activation module that may collect information about execution of the sponsorship program based on the sponsorship proposal. In another such embodiment, information about execution of the sponsorship program may comprise one or more of media buys, signage, deployment of on-site personnel and consumer survey results.

In an embodiment of the invention, the desktop application server comprises a media evaluation module operative to collect information about appearances of the sponsor brand in one or more electronic media sources. In such an embodiment, the media evaluation module may compute a value of appearance of the sponsor brand in electronic media sources.

In an embodiment of the invention, the desktop application server comprises a performance measurement module operative to perform cost/value measurement of an executed sponsorship program based on the information provided by one or more of a leverage and activation module and a media evaluation module.

In an embodiment of the invention, the desktop application server comprises a performance measurement module operative to facilitate a subjective performance measurement of an executed sponsorship. In such an embodiment, to facilitate subjective performance measurement, the performance measurement module may provide a sponsor user with one or more questionnaires that solicit the sponsor user's opinion about effectiveness of an executed sponsorship.

In an embodiment of the invention, the desktop application server comprises a performance measurement module operative to perform a return-on-objective (ROO) measurement of an executed sponsorship.

Further embodiments of the invention comprise the various methods carried out by the foregoing systems.

### BRIEF DESCRIPTION OF THE DRAWINGS

The invention is illustrated in the figures of the accompanying drawings which are meant to be exemplary and not limiting, in which like references refer to like or corresponding parts, and in which:

FIG. 1 is a block diagram of the sponsorship management system according to an embodiment of the invention.

FIG. 2 is a flow diagram of a method for sponsorship proposal management according to one embodiment of the invention.

FIG. 3 is a flow diagram of a method for active sponsorship management according to another embodiment of the invention.

FIGS. 4A and 4B are screen shots of a property user interface according to an exemplary embodiment of the invention.

FIG. 5 is a screen shot of a sponsor user interface according to an exemplary embodiment of the invention.

FIG. 6 is a flow diagram of a method for computing cost/value measure of sponsorship performance according to one embodiment of the invention.

FIG. 7 is a flow diagram of a method for computing subjective measure of sponsorship performance according to one embodiment of the invention.

FIG. 8 is a flow diagram of a method for computing return-on-objective measure of sponsorship performance according to one embodiment of the invention.

### DETAILED DESCRIPTION OF THE INVENTION

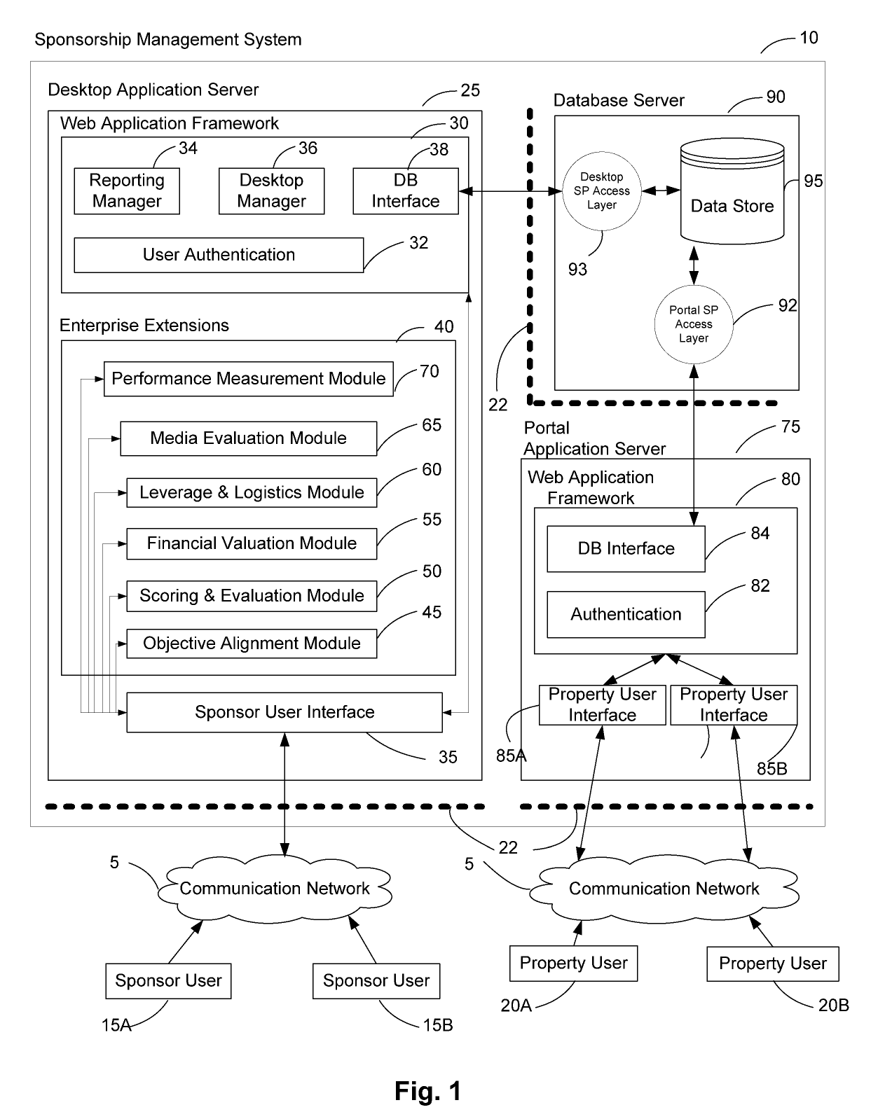

FIG. 1 depicts a network of communicating systems in accordance with one embodiment of the invention. As shown, the network comprises a sponsorship management system 10, which facilitates collection, evaluation, management and measurement of sponsorship proposals for the system users. The sponsorship management system 10 may comprise, e.g., a desktop application server 25, a portal application server 75, and a database server 90. The network may further comprise one or more communication networks 5, such as the Internet, for connecting the sponsorship management system 10 with various users, such as one or more sponsor users 15 and one or more property users 20, according to one embodiment of the invention. The communications networks 5 used by the sponsor users 15 and the property users 20 may be distinct, as depicted in FIG. 1, or they may be the same network, such as the Internet. Well-known means exist for limiting access by one or more classes of users to the appropriate server or servers and/or interface or interfaces.

Access to the sponsorship management system may optionally be controlled by one or more firewalls 22, which are depicted in FIG. 1 by bold broken lines. These firewalls 22 ensure, e.g., that only registered sponsor users 15 and property users 20 may access the sponsorship management system 10 and may do so only through appropriate means, as is described in greater detail below.

A property user 20 may be, e.g., an individual or an organization who represents an event or performer and who uses the sponsorship management system 10 to submit a proposal that solicits paid or non-paid sponsorship of a property from the sponsor user 15. A sponsor user 15 may be an organization that provides sponsorship or an individual employee of such an organization who subscribes to the services of the sponsorship management system 10. A property in this context may include, but is not limited to, an entity hosting a single event or a series of events. An event may include, but is not limited to, an activity that attracts an audience—live or via an electronic medium—for the purpose of providing a common experience for the audience. A proposal may include, but is not limited to, a delineation of specific assets that may serve to associate the sponsor user 15 with one or more aspects of the event. An asset may include, but is not limited to, any tangible or intangible involvement that property user 20 offers to the sponsor user 15 that creates a perceptible association with the event or series of events.

In an embodiment of the invention, the sponsorship management system 10 may include the portal application server 75, which facilitates communication between the sponsorship management system 10 and the property users 20. To that end, the portal application server 75 provides a property user interface 85, through which the property users 20 can submit sponsorship proposals to the sponsorship management system 10, revise submitted sponsorship proposals, and view the status of submitted proposals, as further described below. In the depicted embodiment of the invention, the portal application server 75 further includes a web application framework 80, which provides core functions of the portal application server 75, such as communication with databases and authenticating users. In a preferred embodiment of the invention, the web application framework 80 may include Microsoft's .NET™ framework,

In other embodiments of the invention (not depicted), the portal application server 75 may include other technologies, application frameworks, or both instead of or in addition to the .NET™ framework. For example, a portal application server in connection with an embodiment of the invention may use the Java™ Platform, Enterprise Edition as a platform and further use JavaServer Pages as a specific technology, e.g., to present a property user interface 85. In such an embodiment, the JavaServer Faces framework may serve as a web application framework. Other suitable technologies and frameworks will be readily apparent to those skilled in the art.

One core function of the portal application server 75, which may be provided by the web application framework 80, is database communications. To that end, the web application framework 80 includes a DB interface 84, which facilitates communication between the portal application server 75 and the database server 90, through the Portal SP Access Layer 92. The DB interface 84 may use SQL or other database query language to retrieve data from and to store data in the database server 90. Another core function of the portal application server 75, which may be provided by the web application framework 80, is user authentication. The authentication component 82 authenticates property users who access the portal application server through the property user interface 85 by checking property users' login names and passwords against user access lists maintained by the system.

In one embodiment of the invention, the property user interface 85 may include a Web site having one or more HTML-based pages. The property user interface 85 may be customized for different sponsor organizations. Depending on the embodiment of the invention, the property user interface 85 may include one or more resources that, are deployed separately to a portal application server 75 for each sponser organization. For example, as depicted in FIG. 1, a first property user 20A may submit a proposal to a first sponsor user 15A through a first property user interface 85A, which has been deployed by the first sponsor user 15A, while a second property user 20B may submit a proposal to a second sponsor user 15B, through a second property user interface 85B, which has been deployed by the second sponsor user 15B.

One function of the property user interface 85 is to facilitate collection of sponsorship proposal information from the property users 20. To that end, the user interface 85 presents a questionnaire to the property user 20. These questionnaires are customized to solicit from the property users 20 information about the proposed sponsorship opportunity, which assists sponsor users 15 in evaluation of the proposed opportunity. Depending on the embodiment of the invention and/or the requirements of the sponsoring organization, the questionnaire may vary in its phrasing and/or its organization, e.g., into one or more sections. The questionnaires may be stored in the data store 95 of the database server 90 and be retrieved therefrom through the DB interface 84 when the property user 20 accesses the sponsorship management system 10 through the property user interface 85.

The questionnaires solicit information that the sponsor user 15 may use to evaluate the proposed sponsorship. In an exemplary embodiment, the questionnaire may request information about the property user 20, such as the name of the property user; information about the individual user's organization, including, e.g., the name of the property, the name, title, and contact information of the property representative or agent, the name of the business entity if different from the property. A sponsor user 15 may choose to deploy a questionnaire soliciting other identifying information instead of or in addition to some or all of the foregoing.

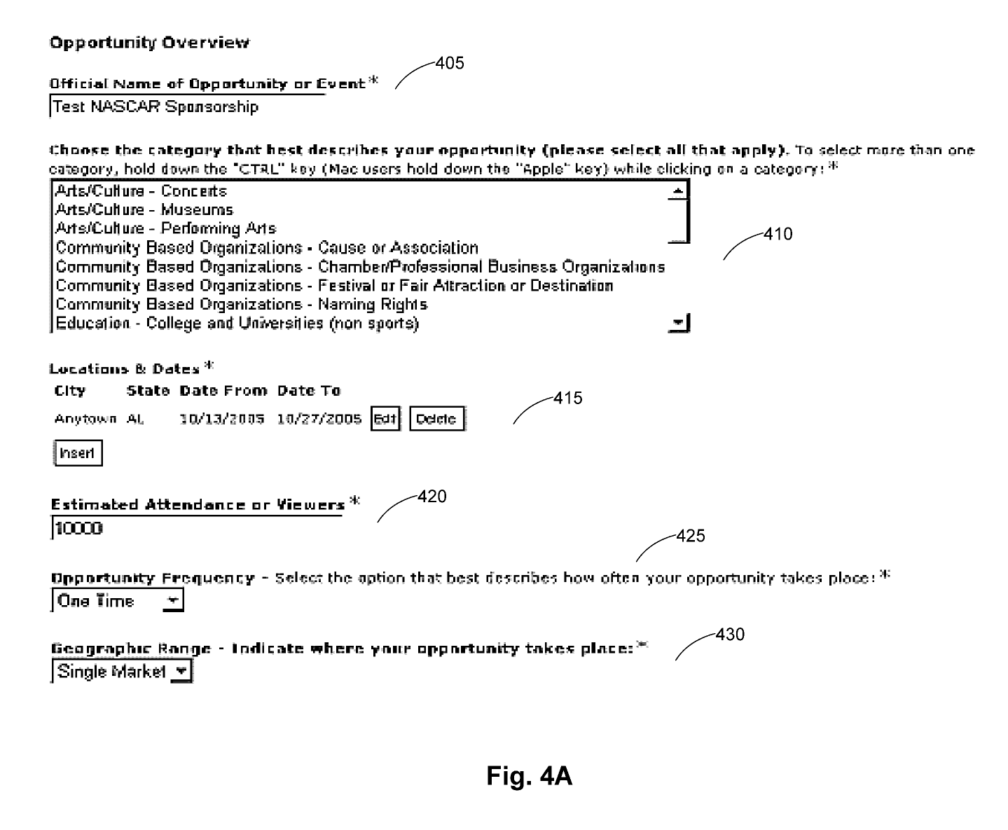

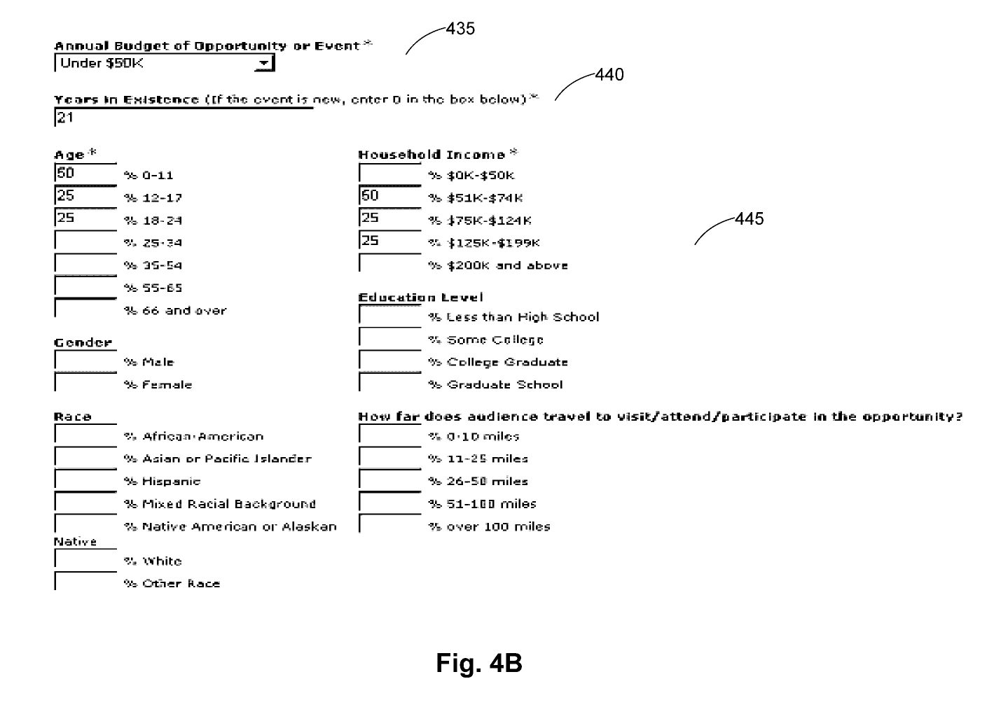

FIGS. 4A and 4B depict an example of a questionnaire according to an embodiment of the invention. As shown, the background information about the property may include, e.g., a property name 405; a property classification (such as art/culture, education, hospitality services, automotive, etc.) 410; property location and the start and end dates of the sponsorship activity 415; the estimated attendance 420; the frequency of the event 425; the number of geographic markets that are covered by or exposed to the event 430; the annual sponsorship budget 435; the years of existence of the event 440; and demographic information (e.g., age, sex, ethnicity, etc.) about the expected audience 445. The questionnaire may inquire into any charitable affiliations (not shown) and prompt the property user to provide brief description of the sponsorship property.

One skilled in the art will understand that the aforementioned information collected from the property user 20 through the property user interface 85 is not limited to that depicted or discussed herein and may include any information related in any way to the property user, the property, and the associated events and assets that may interest the sponsor user 15. To support such variation in gathering information, a questionnaire according to an embodiment of the invention may be modifiable in all respects, including, e.g., the wording and layout of questions, instructions, and prompts and the specific data gathered. In addition to a questionnaire, the property user interface 85 may let the property user 20 submit one or more electronic files—such as hold images, sounds, video, and/or other information—associated with the user's property or one or more events, which can help sponsor users 15 to evaluate the proposed sponsorship opportunity.

In one embodiment of the invention, the property user interface 85 is capable of validating the input from the property user 20. As the property user 20 completes the questionnaire, the system tests entered items to ensure the that no data is missing. In an embodiment of the invention, such validation may include checking, e.g., the format of entered data: for example, if a question asks for a telephone number, the validation may include comparing the entered data to one or more recognized formats for telephone numbers. If errors or missing items are found, the user interface 85 prompts the property user 20 to correct such entries before submitting the questionnaire. In an embodiment of the invention that uses HTML pages, the HTML markup may refer to one or more scripts written in, e.g., JavaScript to validate the entered data.

Once all required information has been entered correctly and submitted, the property user interface 85 passes the collected information to the DB interface 84, which forwards the collected sponsorship proposal information to the database server 90 for storage.

In an embodiment of the invention, the database server 90 may comprise a SQL-based server or any other type of relational database management system, which enables storage, search, and retrieval of the submitted information regarding sponsorship proposals. In alternative embodiments of the invention, the database server 90 may employ a hierarchical database model, network database model, or any other data storage and organization model known to those skilled in the art. The database server 90 may include one or more data stores 95, which may comprise one or more magnetic and/or optical storage devices. The database server 90 may also include a remote backup data store. The portal application server 75 and the database server 90 may optionally be separated by a firewall 22 (depicted by a bold broken line), and this firewall may be configured by a system administrator to assure that only the portal application server 75 and the desktop application server 25 may access the database server 90.

In an embodiment of the invention, access to the database server 90 by the desktop application server 25 may be mediated by a desktop SP access layer 93. Similarly, access to the database server 90 by the portal application server 75 may be mediated by a portal SP access layer 92. Such mediation by the desktop SP access layer 93 and/or the portal SP access layer 92 may implement, for example, load balancing and/or security measures, among other possible features.

In an embodiment of the invention, the sponsorship management system 10 may also include the desktop application server 25, which facilitates communication between the sponsorship management system 10 and the sponsor users 15 as well as the evaluation sponsorship proposals, management of sponsorship assets and measurement of sponsorship performance. To facilitate communication with the sponsor users 15, the desktop application server 25 provides a sponsor user interface 35. The desktop application server 25 further includes a web application framework 30, which provides core functionality of the portal application server 75, such as user authentication, report management, desktop management and database communication functionalities. The desktop application server 25 incorporates an enterprise extension architecture that allows for a plurality of customizable modules, the enterprise extension modules 40, that facilitate proposal evaluation, sponsorship management, and performance measurement.

In one embodiment of the invention, the desktop application server 25 includes the web application framework 30, which in a preferred embodiment of the invention includes Microsoft's .NET framework. Other embodiments of the invention may rely on other frameworks: for example, an embodiment based on the Java Platform Enterprise Edition from Sun Microsystems may include a JavaServer Pages application that includes the JavaServer Faces framework, and many other frameworks are well known to those skilled in the art.

In one embodiment of the invention, the web application framework 30 provides a desktop manager application 36, which facilitates customization and display of the sponsor user interface 35. To provide custom user interface 35, the desktop manager 36 maintains user preferences information, which may include, but not limited to, the order in which the sponsorship proposals are displayed to the sponsor users, such as proposal name, submission date, annual budget and the like; the type of displayed proposals, such as proposals pending approval, approved proposals, rejected proposals and the like.

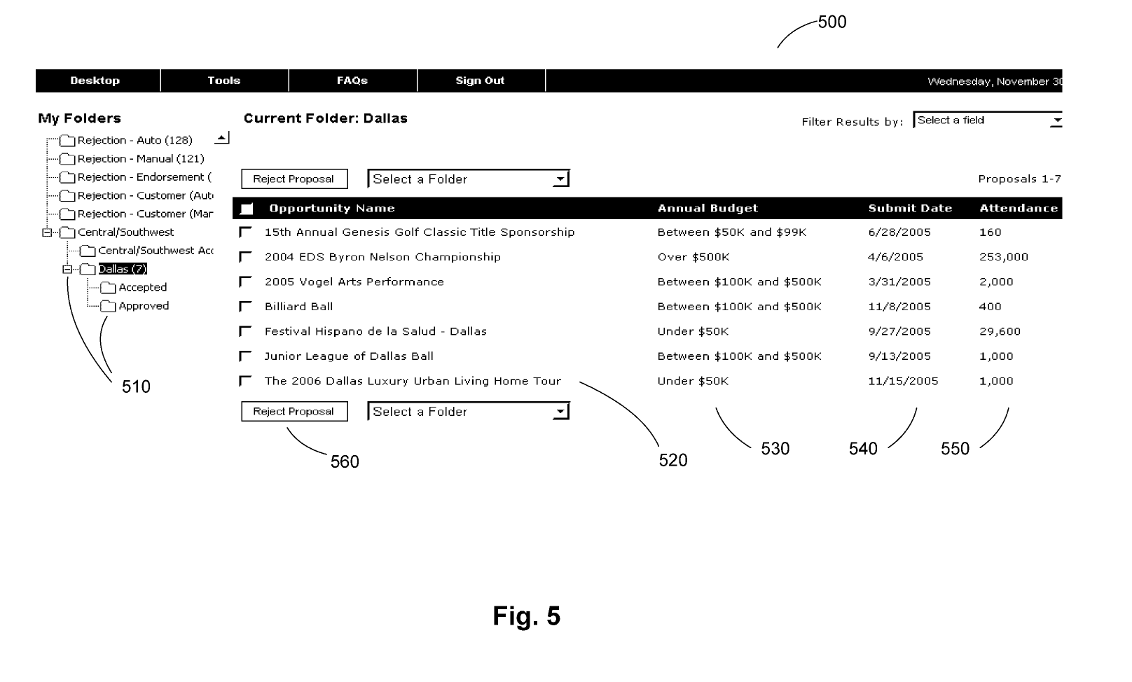

In one embodiment of the invention, the desktop manager 36 organizes the display of sponsorship proposal information to the sponsor users 15. FIG. 5 depicts an example of the sponsor user interface 500 according to an embodiment of the invention, in which sponsorship proposal information is organized in a plurality of folders 510. Each folder 510 may contain one or more subfolders, with each subfolder in turn containing information about one or more sponsorship proposals. The number of folders and their respective contents may vary depending on the requirements and preferences of the sponsor user 15. In one embodiment of the invention, for example, the sponsorship proposals may be sorted into folders based on their status, which may be, e.g., one of pending, approved, and rejected. In another embodiment, the proposals may be sorted by the geographic markets from which the respective proposals have been submitted, such as North America, Europe, China, etc. In yet another embodiment, the proposals may be sorted by the type of industry to which the given sponsorship opportunity relates, such as art/culture, hospitality, or the automotive industry.

The preceding examples are illustrative and not limiting. Those skilled in the art will appreciate that sponsorship proposal information may be sorted according to any one or more attributes of the proposal and/or related information. In an embodiment of the information, the selection of criteria for sorting may be dictated by the needs and/or convenience of the sponsor users 15.

As depicted, on the left portion of the user interface 500, each folder 510 may contain one or more sponsorship proposals 520. On the right side of the screen, the proposal summary grid displays some information about each sponsorship opportunity in the currently selected folder 520. This information is presented in a columnar format much like a spreadsheet (this view is referred to as the “line item view”). Displayed information may include, for example, annual sponsorship budget 530, proposal submission date 540, expected audience size 550, and other information associated with each sponsorship opportunity 520. The sponsor user 15 may click on the name of the sponsorship proposal 520 to view an expanded information area showing additional information about each sponsorship proposal 520 (this is referred to as the “summary detail view”). The sponsor user may use a grid configuration tool feature to customize the exact fields of information displayed in both the line item and summary detail views. This feature allows each sponsor to gain the most efficient access possible to those details in the proposal that are most relevant to the sponsor user's role in the sponsor organization. Having reviewed a sponsorship opportunity, the sponsor user may select one or more sponsorship proposals, e.g., by checking off an adjacent check box, and reject the selected proposal by pressing a reject button 560. All rejected proposals may then be moved to the “rejected folder” in the sponsor user interface 500. The sponsor user may also elect to move one or more proposals to another folder in the system to reflect either another stage in the decision-making process, or approval.

In one embodiment of the invention, the proposal summary grid also includes a view-filtering function, whereby the sponsor user 15 can configure the grid to display only proposals matching particular criteria. This may be used to identify the specific subset of proposals that a sponsor wishes to work with when viewing a folder with a large number of proposals.

In one embodiment of the invention, the sponsor user 15 may also access a global search function that allows the sponsor to specify criteria by which to view proposals across all folders to which the sponsor user 15 has access rights.

In one embodiment of the invention, the web application framework 30 further includes a user authentication component 32. The authentication component 32 authenticates sponsor users 15 by verifying property users' login names and passwords against user access lists maintained by the authentication component 32.

In a preferred embodiment of the invention, the authentication component 32 collects only login names and passwords. In other embodiments, however, the user authentication component 32 may refer to a database comprising information about one or more sponsor users 15, e.g., through the Lightweight Directory Access Protocol (“LDAP”). Such a database may comprise information including, e.g., sponsor user profile and access permission data. In turn, the user profile information may include, e.g., the name and the job title of the sponsor user 15, the department in which the sponsor user 15 is employed, the geographic location of the office in which the sponsor user 15 works, and so forth. In an embodiment of the invention, this additional information may be used, e.g., to enhance access to sponsorship presentation information and the presentation of it.

The user authentication module 32 provides role-based access to the different folders containing sponsorship proposals data maintained by the sponsorship management system 10 according to one embodiment of the invention. The user roles may generally relate to user's decision-making responsibilities and may, for example, be based on the user's job title and department, geographic location of the office in which the sponsor user 15 works, and other parameters. Thus, the sponsor users 15 with different roles may have different access permissions to different folders. For example, some user roles may have full access to all sponsorship folders. Other roles may have limited access to the sponsorship proposal folders, including for example, access to folders containing proposals from a particular geographic market, folders containing proposals having specific annual budget (e.g., $100K to $500K) and the like.

In one embodiment of the invention, the web application framework 30 of the desktop application server 25 may also include a reporting manager 34, which facilitates generation of customized reports having charts, graphs and tables of information related to the evaluation of sponsorship proposals, execution of the sponsorship programs, and measurement of the sponsorship performance. In another embodiment, the web application framework 30 further includes a DB interface 38, which facilitates communication between the desktop application server 25 and the database server 90. The DB interface 38 may use SQL or another database query language to retrieve data from and to store data in the database server 90. In yet another embodiment, the web application framework 30 of the desktop application server 25 includes a communication module (not depicted), which may facilitate distribution of customized email messages to the users of sponsorship management system 10. These email messages may be used, in one example, for notifying a system user of the status of the sponsorship proposals as well as for any changes thereto. Those skilled in the art will appreciate that the web application framework 30 may further include other core functionality modules.

The workflow architecture provides a logical framework for executing automated tasks based upon the state of a proposal, with the state usually indicated by the folder in which the proposal is located. Workflow architecture allows for a number of automated processes including but not limited to automated email notification systems, filtering/routing systems, and data exporting systems. In one embodiment of the invention, upon submission of the proposal, the workflow architecture is configured to send an acknowledgement email to the submitter. The workflow architecture is further configured to route proposals to an appropriate folder within the sponsor desktop, based upon matching data in the submitted proposal to sponsor-defined criteria. Thus, the workflow architecture automates and facilitates the review process by automatically rejecting inappropriate proposals and removing the administrative overhead associated with getting a proposal into the right reviewer's hands.

In an embodiment of the invention, the sponsorship management system 10 includes a plurality of enterprise extension modules 40, which facilitate proposal evaluation, sponsorship management and performance measurement. To facilitate evaluation of sponsorship proposals, the desktop application server 25 provides objectives alignment module 45, scoring and evaluation module 50 and financial valuation module 55 according to one embodiment of the invention. To facilitate management of sponsorship programs, the desktop application server 25 provides leverage and activation module 60 and media evaluation module 65. To facilitate measurement of sponsorship performance, the desktop application server 25 provides the performance measurement module 70 according to one embodiment of the invention. Each of the enterprise extension modules 40 are described in greater detail below.

In an embodiment of the invention, the desktop application server 25 provides an objectives alignment module 45, which facilitates the evaluation of proposal fitness against one or more sponsor defined “objectives profiles” stored in a database server 90. These profiles are created by the sponsor organization to reflect general objectives of the sponsorship programs that the sponsor organization is interested in supporting. In one embodiment, the objective profile may comprise three components. The first component includes one or more strategic marketing objectives such as increasing brand awareness, increasing product sales, driving trial usage, etc. The second component includes one or more target demographics, such as college educated women age 20 to 35. The third component includes a list of brand attributes with which the sponsor organization wishes to be associated. Example brand attributes are “hip”, “outdoors”, “wealth aspiring”, “tough”, “reliable”, etc.

Upon submission of a new sponsorship proposal, the objectives alignment module 45 evaluates the fitness of the sponsorship proposal to the defined objective profiles using a mapping algorithm. In one embodiment, the algorithm defines a plurality of weighted relations between the strategic sponsorship objectives specified in the objective profiles and data provided by the property users in response to the new proposal questionnaires. Such data may include, but is not limited to, proposal benefits (e.g., on-site signage, hospitality, sales access, media co-branding, etc.), target demographics and demographic data, and finally brand attributes and the proposal's opportunity category (e.g., baseball, food festival, jazz concert, etc.). These relations may be set as defaults by the objectives alignment module 45 and can be modified by the sponsor users 15.

Having performed such mapping, the objectives alignment module 45 may generate proposal fitness scores that reflect the proposal's match to each defined objective profile as well as the comparative closeness of those matches to the matches of other sponsorship opportunities. For example, having performed an objectives alignment on a new sponsorship proposal, the objectives alignment module 45 may in an embodiment of the invention indicate that the new proposal is 60% aligned with the strategic sponsorship objectives specified in one or more objective profiles. Simultaneously, the objectives alignment module 45 may indicate that, compared to other submitted sponsorship proposals, the given sponsorship proposal has the highest or the second-highest degree of alignment with strategic sponsorship objectives.

In an alternative embodiment of the invention, the fitness score indicating the match between the proposal and objective profiles may be presented in association with the proposal, and the average score across all profiles may be presented simultaneously.

In an embodiment of the invention, the desktop application server 25 also provides a scoring and evaluation module 50, which facilitates objective and subjective evaluation of the new sponsorship proposals. The objective evaluation may be performed automatically by the system on all new proposals to eliminate off-strategy sponsorships. In an exemplary embodiment of the invention, the objective evaluation may be based on such criteria as national platform fit, brand fit and geographic footprint. The national platform criterion may be used to determine whether the proposed property matches sponsor user's 15 national sponsorship categories, such as sports (e.g., baseball, NASCAR, Olympics, golf, etc.), community-based organizations (e.g., chamber/professional organizations, festivals, fair attractions, etc.) and arts/culture events (e.g., museums, concerts, performing arts, etc.). If the new sponsorship proposal does not fall within one of these categories, the proposal may be automatically rejected without further review by a sponsor user 15.

The brand fit criteria may be used to determine whether proposed property matches sponsor user's 15 brand guidelines for sponsorships. For example, if the new proposal is for individual endorsements or activities related to the liquor, tobacco or gaming industry, such proposals may be automatically rejected during objective evaluation. Lastly, the geographic footprint criterion may be used to determine whether the sponsored property or the sponsored event is located within geographic region of operation of the sponsor organization. For example, the sponsor organization may be interested in sponsoring only events within or which have an exposure to one or more defined geographic markets (e.g., East Coast, North America, Europe, China, etc.). Thus, proposals for sponsorship in other geographic markets may be automatically rejected by the system without further review by a sponsor user 15.

To facilitate subjective evaluation of the new sponsorship opportunities, the scoring and evaluation module 50 provides sponsor user 15 with a plurality of electronic questionnaires according to one embodiment of the invention. The questionnaires solicit the sponsor user 15 to subjectively evaluate the property user 20 and the proposed sponsorship opportunity. These questionnaires may be created by the sponsorship management system 10 or by the sponsor organization, and loaded into the database server 90, to assist sponsor users 15 in subjective evaluation of the proposed sponsorship opportunities. These questionnaires assure that all sponsor users 15 evaluate the sponsorship opportunities based on the same set of criteria, whereby assuring that the subjective evaluation process is uniform and consistent.

In an exemplary embodiment of the invention, the subjective scoring questionnaire may ask the sponsor user 15 to evaluate the property user 20 based on three broad categories of questions: (1) What is the proposed level of involvement and how many other companies are involved? (2) How does the potential property user 20 demonstrate sponsors' business priorities, brand attributes, and core values? (3) What are the risks to the sponsor user 15 of partnering with this property user 20? Of course, this list of questions is not limited, and an embodiment of the invention may include other questions that assist sponsor user 15 in evaluation of the proposed sponsorship opportunity.

To further assist the sponsor user 15 in evaluation of the sponsorship opportunity, each category of subjective questions may be further divided into subcategories of questions, which clarify to the sponsor user 15 what is being asked of them.

With respect to the second category of questions, the sponsor user 15 may be asked questions regarding the quality and/or leadership of the property. Without limitation, examples of such questions include: Do they have a track record of excellence? Does the company or entity meet or exceed industry benchmarks? How long have the event and/or property been in existence?

The sponsor user 15 may further be asked questions regarding the trustworthiness and integrity of the property, the related organization, or both. Such questions may concern, e.g., the organization's reputation for leadership and integrity and commitment to community service. The sponsor user 15 may also be asked questions regarding their market priorities and how well those priorities align with those of the of the property, its related organization, or both.

The third category of questions relates to potential risks to the sponsor. The sponsor user 15 may therefore be asked questions regarding, e.g., the type and/or length of sponsorship commitment, including the conditions under which the sponsor can effectively end the relationship. Other questions in this category may relate to potential negative associations involving the property user 20, such as might stem from, e.g., outstanding litigation, financial instability, noncompliance with various administrative and industry-wide guidelines, or potentially negative associations with other entities (e.g., controversial owners, players, performers, other sponsors, etc.).

The sponsor user 15 may also be asked questions regarding the measurement of the results of sponsorship. Such questions may concern, e.g., the internal and external systems and resources in place that need to track and measure return on investment (ROI), which may take forms such as improvement in local brand health and purchase consideration, increase in net new relationships, increase in customer loyalty, etc.

In an embodiment of the invention, the sponsor user 15 may be provided with selectable answers to the foregoing questions, each selectable answer having a score associated therewith. For example, in response to a question about the property user's reputation for probity, the sponsor user 15 may have five choices, with “least trustworthy” assigned a score of 1, “average trustworthiness” assigned a score of 3, and “most trustworthy” assigned a score of 5. In any particular embodiment of the invention, the choice of questions, answers, and associated scores may be expected to vary depending on the needs and goals of the sponsoring organization.

Once the subjective evaluation is complete, the scoring and evaluation module 50 weights and combines all the scores to generate a final score for the evaluated sponsorship proposal, which the sponsor user 15 may use to decide whether to pursue the given sponsorship opportunity. In an embodiment of the invention, a sponsor user 15 may be provided with guidelines for evaluating scores, and such guidelines may, for example, prescribe that ranges of scores are to be used to group proposals for further action. Such guidelines may also, for example, prescribe that scores falling below a certain cutoff are to be rejected without further review.

In an embodiment of the invention, the application server 40 may also provide a financial valuation module 55, which facilitates financial valuation of the sponsorship assets. In particular, the financial valuation module 55 may maintain a database of monetary values for various types of assets, such as advertising pre-event, advertising post event, media advertising, broadcast coverage and the like. The value of each asset further depends on the geographic market where such asset is located. For example, a radio broadcast asset, may have different values depending on the geographic market of such broadcast. In New York City, for example, the value of this asset may be $10,000, while the value of the same asset in Albany may be only $1000. In this manner, the financial valuation module 55 values all assets related to the proposed sponsorship opportunity and generates an estimated value of the sponsorship. An embodiment of the financial valuation method, which may be implemented in the financial valuation module 55, is described in greater detail in the commonly-owned patent application entitled Proposal Asset Valuator, Ser. No. 60/534,525, filed Jan. 6, 2004, which is incorporated in its entirety by reference herein.

In an embodiment of the invention, the application server 40 also provides a leverage and activation module 60, which facilitates tracking of the resources that may be used to measure performance of a sponsorship program. In particular, the leverage and activation module 60 provides to the sponsor user 15 a user interface 35, which may be used to collect from the sponsor user 15 information related to the execution of the sponsorship program, including, for example, information about the costs of media buys and signage, the deployment of on-site personnel, consumer survey results and the like. The leverage and activation module 60 compiles the collected information and records it in the proposal database. In addition, the leverage and activation module may track all costs associated with the leverage and execution of the sponsorship program against a predefined budget established by the sponsor user 15.

In one embodiment, of the invention, the leverage and activation module 60 is further configured to use the reporting manager 34, which may be used to generate custom reports on the status of the execution of the sponsorship program from the data provided by the leverage and activation module 60. For example, through a user interface 30, the sponsor user 15 may request a report summarizing leverage and activation costs of an executed sponsorship program. Having received such a request, the leverage and logistic module 60 may access database server 90 to retrieve all information related to that aspect of execution of the sponsorship program. The leverage and activation module 60 may then pass this data to the reporting manager 34, which would format the received data for presentation to the user, using tables, charts, diagrams and the like.

In other embodiments of the invention, the leverage and activation module 60 provides other applications and system components with information related to the execution of the sponsorship program. For example, the leverage and activation module 60 creates data that the data store will subsequently provide to the performance measurement module 70. In particular, the performance measurement module 70 may request information related to the actual and estimated expenses associated with the execution of a sponsorship program, so that it can measure performance of the sponsorship opportunity, as described in greater detail below. The leverage and activation module 60 is configured to identify and to retrieve the requested data from the database server 90 and to provide the retrieved data to the performance measurement module 70.

In other embodiments of the invention, the media evaluation module 65 provides other applications and system components with information related to the appearances of the sponsor brand in various media sources as well as estimated value of such appearances. For example, the media evaluation module 65 is configured to receive from the performance measurement module 70 requests for data related to value of the sponsor brand appearances in mass media, so that it can measure performance of the sponsorship opportunity, as described in greater detail below. The media evaluation module 65 is configured to identify and to retrieve the requested data from the database server 90 and to provide the retrieved data to the module 70.

In an embodiment of the present invention, the desktop application server 25 further provides a performance measurement module 70, which facilitates measurement of effectiveness of a sponsorship program, based on the information submitted in the sponsorship proposal as well as the information collected by the leverage and activation module 60 and media valuation module 65. In one embodiment of the invention, the performance measurement module 70 provides several disparate mechanisms for measuring effectiveness of the sponsorship program, including, but not limited to, cost/value analysis and subjective performance measurement analysis, which may also include a return-on-objective (ROO) analysis, each as explained forth below. Those skilled in the art will appreciate that the effectiveness of the sponsorship program may be measured using other techniques including, for example, measurement of a return-on-investment (ROI) and other performance measurement techniques known in the art.

In one embodiment of the invention, the performance measurement module 70 is operative to perform cost/value analysis of the sponsorship program. To conduct this analysis, the performance measurement module 70 may first request from the leverage and activation module 60 information about the costs of execution of the sponsorship program, including, but not limited to, amount of funds provided to the sponsor property as well as expenditures related to media buys, signage, on-site personnel and the like. In response, the leverage and activation module 60 retrieves the requested information from the proposal database 85 and forwards it to the performance measurement module 70. The received costs data may be processed by the performance measurement module 70 to determine the total cost of the sponsorship program. For example, the processing of data may involve conversion of all foreign currency monetary amounts into US dollars. In addition, various weighting factors determined by the sponsor users 15 may be applied to the received cost data. Lastly, the converted and weighted cost data may be added to compute the total cost of the sponsorship program.

In determining the value of the sponsorship program, the performance measurement module 70 may again use information provided by the leverage and activation module 60 as well as the information provided by the media evaluation module 65. In particular, the leverage and activation module 60 may provide, e.g., a list of all costs. The performance measurement module may further use information about post-event statistics and consumer surveys, which was submitted by the sponsor user 15A through the sponsor use interface 35. Such information may also include, without limitation, the number of attendees of the sponsored event, the amount of media coverage, and other factors. The media evaluation module 65 may provide such information as a number of appearances of the sponsor brand in various mass media sources and the value of such appearances.

The received value data may be processed by the performance measurement module 70 to determine the total value of the sponsorship program. For example, the processing of data may involve conversion of all foreign currency monetary amounts into US dollars. In addition, various weighting factors determined by the sponsor users 15 may be applied to the received value data. Lastly, the converted and weighted value data may be added to compute the total value of the sponsorship program. The performance measurement module 70 then computes a cost/value ratio, which is an indicia of effectiveness of the sponsorship program.

In another embodiment of the invention, the performance measurement module 70 enables sponsor users 15 to subjectively measure performance of the sponsorship program. In one embodiment of the invention, the subjective measurement of the sponsorship program may be performed via one or more electronic questionnaires, which solicit the sponsor user 15 to subjectively evaluate performance of the sponsorship program. These questionnaires may be created by the sponsorship management system 10 or by the sponsor organization, and loaded into the database server 90, to assist sponsor users 15 to subjectively measure sponsorship. These questionnaires assure that all sponsor users 15 evaluate the sponsorship performance based on the same set of criteria, whereby assuring that the subjective performance measurement is consistent among different sponsor users 15.

In an exemplary embodiment of the invention, sponsor users 15 may access the subjective measurement questionnaires through the sponsor user interface 35. The provided questionnaire may have a plurality of questions and sample answers, which solicit opinion of the sponsor user 15 about performance of the sponsorship program. The sample questions may include: (1) How cooperative/helpful was the property user 20 during and after execution of the sponsorship program? (2) How effective was the sponsorship program in demonstrating sponsor user's 15 priorities, brand attributes and core values? (3) Were there any negative results of the sponsorship program? Of course, this list of questions is not limited and may include other questions that assist sponsor user 15 in subjectively measuring performance of the sponsorship program.

As indicated above, the subjective performance questions may be accompanied by one or more sample answers, each having a predefined number of points associated therewith, such as, for example, on a scale form one to five. By choosing answers which most closely reflect sponsor user's 15 opinion about the various aspects of performance of the sponsorship program, a cumulative score may be computed by the performance measurement module 70. This score reflects opinion of the sponsor user 15 about the overall effectiveness of the sponsorship program. This cumulative score is a subjective measure of the effectiveness of the sponsorship program.

In yet another embodiment of the invention, the performance measurement module 70 is operative to perform return-on-objective (ROO) measurement of the effectiveness of the sponsorship program. The ROO measurement may be performed on one or more strategic sponsorship objectives selected by the sponsor user. Such strategic objective may include an objective to increase sponsor brand awareness or an objective to increase sales of sponsor's products.

The sponsor user then may determine one or more specific tactical objectives that relate to the selected strategic sponsorship objective. Such tactical objectives may, for example, include, but are not limited to, to reach an audience of 10,000 with the given sponsorship program, to increase the number of new customers in the region where the sponsorship program took place by at least 2,000, to increase the sales of the sponsor's products to individuals of particular demographic by at least 50% and the like. Those skilled in the art may recognize that the aforementioned tactical objectives are merely exemplary and the sponsor users 15 may select other tactical objectives that may be used for computation of ROO for the selected strategic objective.

Next, the sponsor user 15 may specify a tactical objective measure of the sponsorship performance for each selected tactical objective. These tactical objective measures may be acquired from the post-event surveys and statistics related to the executed sponsorship. Thus, the sponsor user may indicate that the audience of the sponsored event was 6,000 people, that the number of new customers in the in the region where the sponsorship program took place had increased by 3,000, that the sales of the sponsor's products had increased by 30% as a result of the sponsorship program, and the like.

The performance measurement module 70 may then compute the percent of success score for each tactical objective based on the corresponding tactical objective measures. For example, if a strategic sponsorship objective of the sponsorship program was to increase brand awareness and a related specific tactical objective of the sponsorship program was to reach an audience of 10,000, the performance measurement module 70 may compute that there is a 100% success of this objective if the post-event statistics indicate that at least 10,000 people attended the sponsored event, which featured sponsor's brand. However, if the post-event statistics indicate that merely 7,000 people attended the sponsored event, the module 70 may compute that there is only a 70% success of this strategic sponsorship objective.

In another example, if a strategic sponsorship objective of the sponsorship program was to increase sales of the sponsor's products and a specific tactical objective of the sponsorship program was to increase sales of the sponsor's products by 30% in a particular geographic market or to customers of particular demographic, the sponsor user 15 may confirm a 100% success of this objective if the products sales numbers within the given geographic region or the results of the post-event surveys conducted by sponsor user 15 among customers of the given demographic, indicate the desired increase in the sales of sponsor products. However, if the survey results indicate only a 15% increase in sales of sponsor products as a result of the sponsorship program, the sponsor user 15 may indicate that this strategic sponsorship objective was only 50% successful.

The performance measurement module 70 may then compute a return-on-objective (ROO) measure based on the calculated percentile success scores. To that end, the performance measurement module 70 may first apply various weighting coefficients to the percentile scores for each sponsorship objective. The coefficients may be defined by the sponsor user 15 and indicate the degree of importance of the given sponsorship objective with respect to other sponsorship objectives. Thus, in one embodiment, all sponsorship objectives may be weighted equally, while in another embodiment some objectives may have a greater weight than others. Having computed weighted percentile scores, the performance measurement module 70 may then combine such weighted scores to generate a cumulative return-on-objective measure, which indicates objectives-based effectiveness of the sponsorship program.

One skilled in the art should understand that the functionality of the desktop application server 25 is not limited to the above-described applications. It is within the scope of the invention that the sponsorship performance management system 10 may include other customizable applications and system components that facilitate evaluation of sponsorship proposals, management of active sponsorship programs and measurement of performance of the completed or active sponsorship programs. It should be noted that sponsor organization may choose one or more of the aforementioned enterprise extension applications 40 to be available for sponsor users 15. Thus, one sponsor organization may select all of the aforementioned enterprise extension applications 40, while another sponsor organization may decide not to use objectives alignment module 45 and media evaluation module 65, for example.

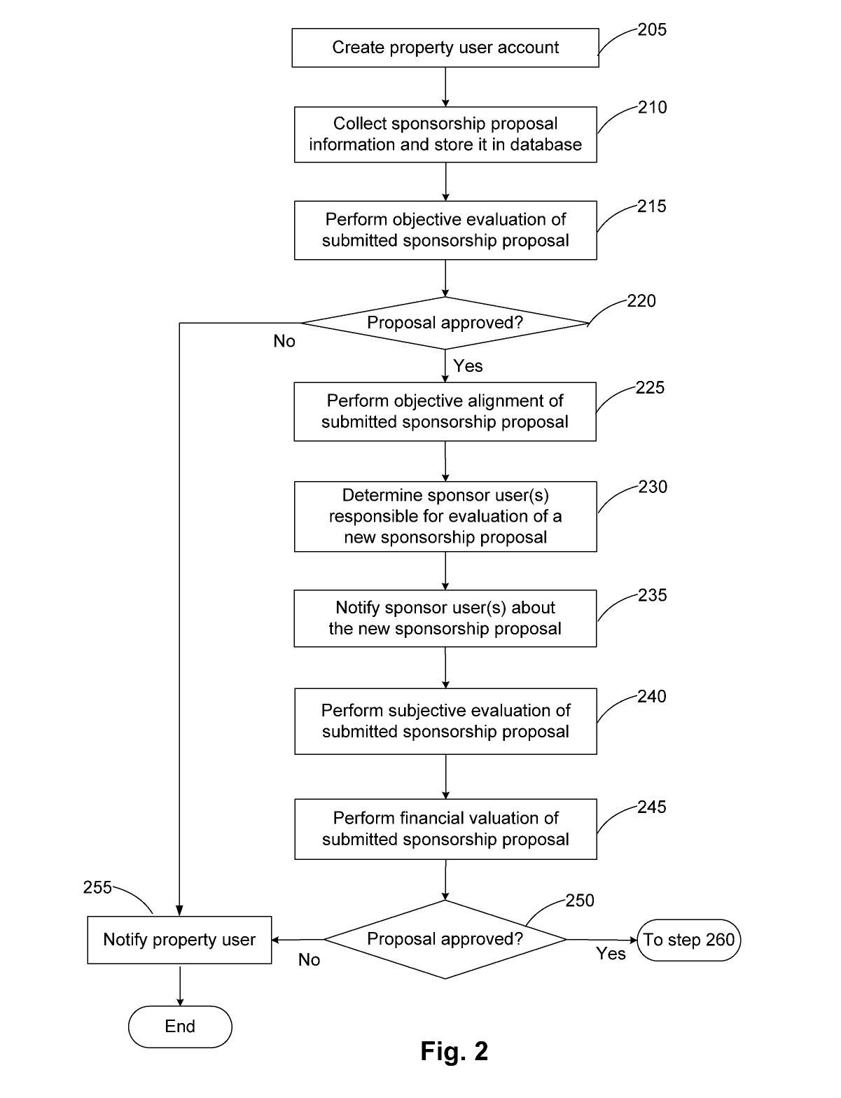

FIG. 2 illustrates one embodiment of operation of the system for managing of sponsorship programs. To submit a sponsorship proposal, a property user may access a Web site provided for that purpose by the sponsorship management system. At the Web site, the property user may create a new user account, step 205, or if such an account already exists, log in using his user name and password. If the login is successful, the system presents to the property user a graphical user interface. Through this interface, the property user can create new sponsorship proposals for submission to the sponsor organization or view the status of the existing sponsorship proposals and active sponsorship programs.

To facilitate creation of a new sponsorship proposal, the user interface provides to the property user one or more questionnaires, which facilitate collection from the property user of information about the property user and information about proposed sponsorship opportunity, step 210. The questionnaire may solicit from the property user the following information: information about the individual user's identity and identity of their organization; name of the property, its classification and location; the start and end dates of the sponsorship activity; the estimated attendance; the frequency of the event; the number of geographic markets that are covered by or exposed to the event; the annual sponsorship budget; the years of existence of the event; and various demographics information about the attending audience, such as age, gender, ethnicity and the like. The information provided by the property owner through the questionnaire may be stored by the system in a proposal database, step 210.

Once all of the information about a new sponsorship opportunity is collected, the system may perform an objective evaluation of the submitted sponsorship proposal to eliminate off-strategy proposals at the early stage of the evaluation process, step 215. In particular, the system may conduct a quick evaluation analysis, which determines whether the new sponsorship proposal meets certain essential objective sponsorship criteria established by the sponsor user, such criteria may include, for example, national platform fit, brand fit and footprint. The national platform criterion may be used to determine whether the proposed property matches sponsor user's 15 national sponsorship categories, such as sports, community-based organizations, arts/cultural events and others. The brand fit criteria may be used to determine whether proposed property matches sponsor organization brand guidelines, such as no individual endorsements or activities related to the liquor, tobacco or gaming industry. Lastly, the footprint criterion may be used to determine whether the sponsored property or the sponsored event is located within geographic region of operation of the sponsor organization. If the submitted sponsorship proposal does not pass this initial objective evaluation, step 220, the proposal evaluation process is terminated and the property user is notified about the rejection of his sponsorship proposal, step 255.

If the new sponsorship proposal passes objective evaluation, step 220, the system may perform objectives alignment on the new sponsorship proposal, step 225. In particular, the system facilitates the evaluation of proposal fitness against one or more sponsor defined objectives profiles, which may include one or more strategic marketing objectives, such as increasing brand awareness and increasing product sales, one or more target demographics, such as college educated women age 20 to 35, and a list of brand attributes with which the sponsor organization wishes to be associated, such as “hip”, “outdoors”, etc. During objectives alignment, the system defines a plurality of weighted relations between the strategic marketing objectives specified in the objective profiles and data provided by the property users in response to the new proposal questionnaires. The system then generates a proposal fitness score that reflects the proposal's percentage match to each defined objective profile as well as to other sponsorship opportunities.

Next, the system may determine which sponsor user(s) is responsible for further evaluation of the new sponsorship proposal, step 230. In making this determination, the system may consult user profile databases and in particular, user roles. As indicated above, the user roles may generally relate to user's decision-making responsibilities and may, for example, be based on the user's job title and department, geographic location of the office in which the sponsor user works and other similar parameters. Thus, the system compares various parameters of the new sponsorship proposal to the parameters defining different user roles. For matching parameters, the system sends email massages to all sponsor users associated with matching role, step 235. The email message notifies these users about submission of a new sponsorship proposal, which met user objectives.

Having received an email notification from the sponsorship management system regarding new sponsorship proposal, a sponsor user may log in to the system to review the newly submitted sponsorship proposal. At this stage, the system may facilitate subjective evaluation of the new sponsorship proposal, step 240. In particular, the system provides a questionnaire, which solicits from the sponsor user his opinion about the reviewed sponsorship proposal. For example, the questionnaire may pose the following questions: What is the proposed level of involvement of the sponsor and how many other companies are involved in the sponsorship? How does the potential property user demonstrate sponsors business priorities, brand attributes and core values? What are the risks to the sponsor user if he partners with this property use? Of course, this list of questions is not limited and may include other questions that assist sponsor user in the evaluation of the proposed sponsorship opportunity. The answers provided by the sponsor user are scored on a predefined scale and a total cumulative subjective evaluation score is generated by the system. Depending on that score, the sponsor user may decide whether to reject the given sponsorship proposal, to pass it to other sponsor user for additional review, or to approve the reviewed sponsorship proposal.

Also at this stage, the system may perform a financial evaluation of the submitted sponsorship proposal, step 245, as described in greater detail above. The financial valuation of the sponsorship opportunity assists sponsor user in deciding whether to approve or to deny the given sponsorship proposal. An embodiment of the financial valuation process was described in greater detail above. Next, if the system determines that the proposal has been rejected by the sponsor user, step 250, the system may send an email message notifying the property user about rejection of his sponsorship proposal, step 255. If, however, the sponsorship proposal was approved, the system may send an email message notifying the property owner about approval of his sponsorship proposal. The system may then proceed with the execution of the sponsorship program, step 260.

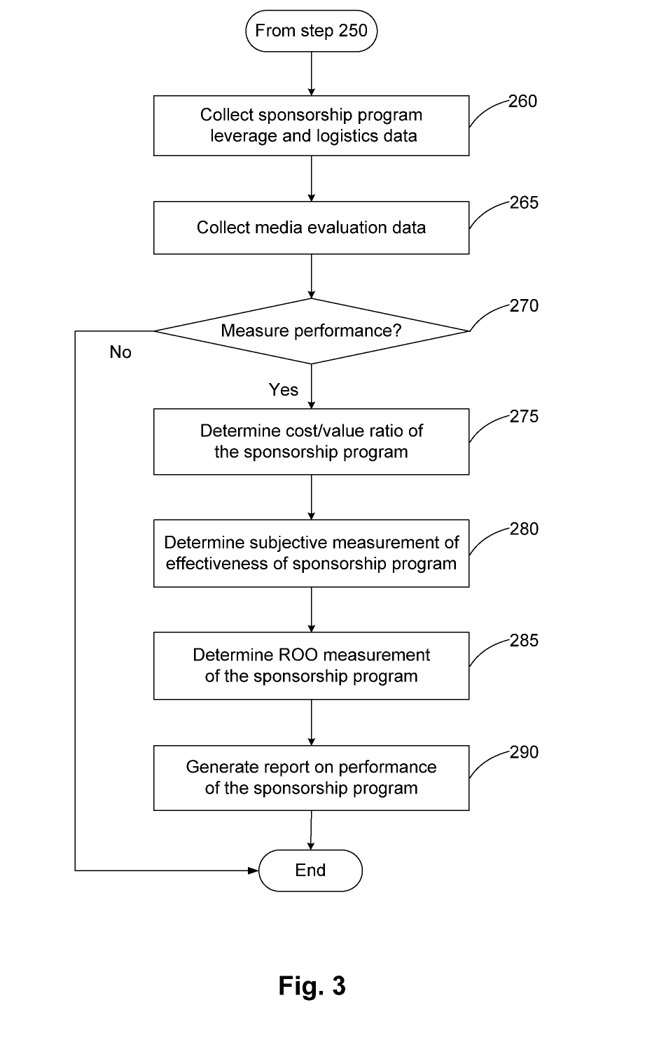

FIG. 3 illustrates another embodiment of operation of the system for managing of active sponsorship programs. Once a new sponsorship proposal is approved and the execution of the sponsorship program is commenced, the system may be configured to collect leverage and activation data for the executed sponsorship program, step 260. At this stage of the process, the system tracks all resources needed to carry out execution of the given sponsorship program, such as media buys, signage, on-site personnel and the like. The system may also record costs of the execution of the sponsorship program and check them against an established budget for the leverage and execution. In addition, the system may perform identification, collection and maintenance of information related to the appearance of sponsor's brand identifiers in various mass media sources, step 265. All the collected information may be stored in a proposal database for further processing.

During execution of the sponsorship program or upon termination thereof, a sponsor user may log in to the system and using sponsor user interface, can review performance of the sponsorship program, step 270. Having received such a request, the system may perform several different performance measurement analyses based on the collected leverage and activation data as well as media evaluation data. In particular, the system may conduct cost/value analysis of the sponsorship program, step 275. The system may also compute a subjective measure of the performance, step 280. The system may also determine return-on-objective measure of the sponsorship performance, step 285. Each of these analyses will be in greater described below. Lastly, the system may generate a report on the results of performance of the sponsorship program, step 290.

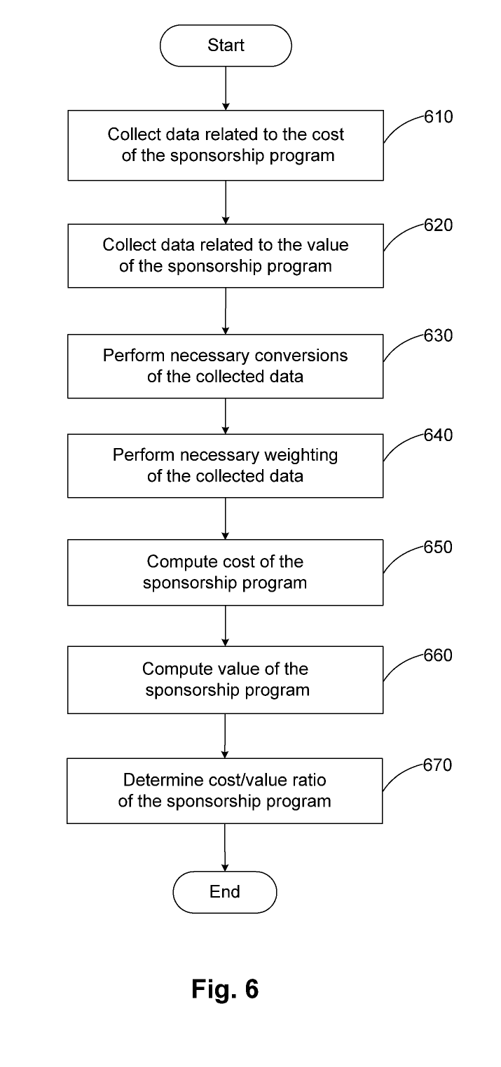

With reference to FIG. 6, disclosed is a method for cost/value measurement of sponsorship performance according to one embodiment of the invention. To compute cost of the sponsorship program, the system may retrieve from the proposal database information about the costs of execution of the sponsorship program, step 610. The retrieved cost information may include, but is not limited to, amount of funds provided to the sponsor property as well as expenditures related to media buys, signage, on-site personnel and the like. In determining value of the sponsorship program, the system may retrieve from the proposal database information related to the value of the sponsorship program, step 620. Such information may include information about post-event statistics and consumer surveys, as well as media related data, such as the number of attendees of the sponsored event, the amount of media coverage, the number of appearances of the sponsor brand in various mass media sources and the value of such appearances.

The system may then perform necessary currency conversions of the collected data, step 630, and apply various weighting coefficients to the collected data, step 640. Having conducted the conversion and weighting operations, the system may combine all cost data to compute the total cost of sponsorship, step 650. Likewise, the system can add all value data to compute the total value of the sponsorship, step 660. The system may then compute cost/value ratio of the sponsorship program, step 670.

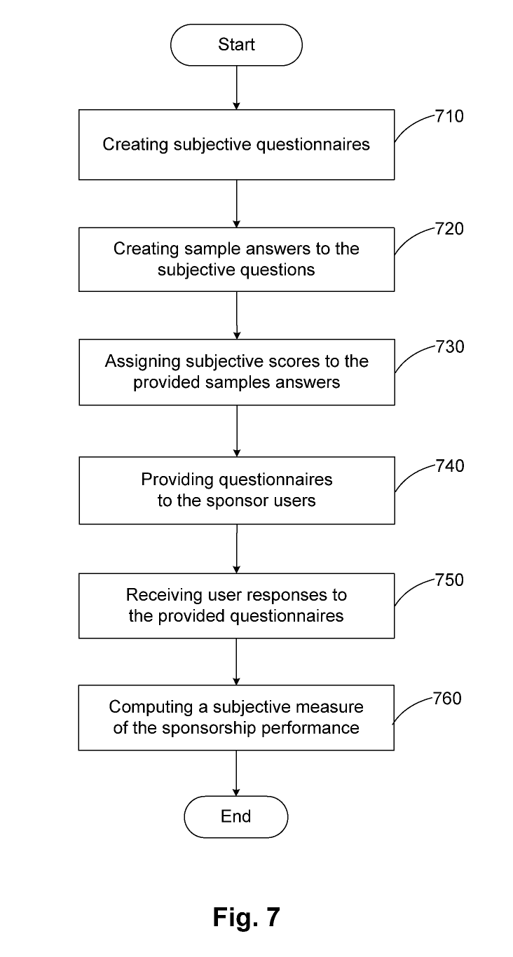

With reference to FIG. 7, depicted is a method for subjective measurement of sponsorship performance according to one embodiment of the invention. To conduct a subjective performance measurement of a sponsorship program, the system facilitates creation one or more questionnaires operative to solicit the sponsor user to subjectively evaluate the performance of the sponsorship program, step 710. These questionnaires may be created by the sponsorship management system or by the sponsor organization, and may be stored in a database of the proposal management system. In addition, the system facilitates creation of sample answers for the subjective questionnaire step 720. The system also facilitates an assignment of value scores to each sample answer, step 730.

Having created such subjective questionnaires and the associated sample answers, the system may provide these questionnaires to the sponsor user to facilitate subjective measurement of performance of the sponsorship program, step 740. The system receives from the sponsor user answers to the provided questionnaires which indicate sponsor user's opinion about the various aspects of performance of the sponsorship program, step 750. Then, by adding scores from each user-provided answer, the system computes a cumulative subjective score, step 760, which indicates the subjective opinion of the sponsor user about overall effectiveness of the sponsorship program.

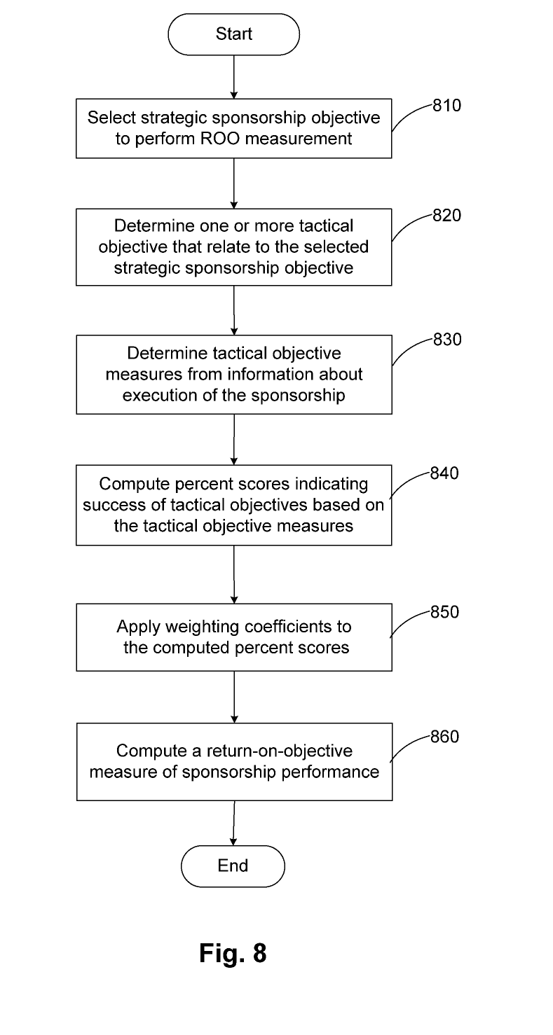

With reference to FIG. 8, depicted is a method for return-on-objective (ROO) measurement of sponsorship performance according to one embodiment of the invention. The ROO measurement may be performed on one or more strategic sponsorship objectives selected by the sponsor user, step 810. Such strategic objective may include an objective to increase sponsor brand awareness or an objective to increase sales of sponsor's products. The sponsor user may then determine one or more specific tactical objectives that relate to the selected strategic sponsorship objective, step 820. Examples of specific tactical objectives include an objective to reach an audience of 10,000 with the given sponsorship program, an objective to increase the number of new customers in the region where the sponsorship program took place by at least 2,000, an objective to increase the sales of the sponsor's products to individuals of particular demographic by at least 50% and the like.

Next, the sponsor user may specify a tactical objective measure of the sponsorship performance for each selected tactical objective, step 830. These tactical objective measures may be acquired from the post-event surveys and statistics related to the executed sponsorship. Thus, the sponsor user may indicate that the audience of the sponsored event was 6,000 people, that the number of new customers in the in the region where the sponsorship program took place had increased by 3,000, that the sales of the sponsor's products had increased by 30% as a result of the sponsorship program, and the like.

The system may then compute the percent of success score for each tactical objective based on the corresponding tactical objective measures, step 840. For example, if the specific tactical objective of the sponsorship was to reach an audience of 10,000 and the actual audience was only 6,000, the percent of success score for the given tactical objective was only 60%. In another example, if the specific tactical objective of the sponsorship was to increase the number of new customers in the region where the sponsorship took place by at least 2,000 and the actual number of new customers had increased only by 1,000, there is only 50% success of the given tactical objective.

The system may then apply various weighting coefficients to the percentile scores for each specific tactical objective, step 850. The coefficients may be defined by the sponsor user and indicate the degree of importance of the given tactical objective with respect to other tactical objectives related to the same strategic sponsorship objective for which ROO is measured. The system may then combine all weighted scores for the specific tactical objectives to generate a cumulative return-on-objective measure for the selected strategic sponsorship objective, step 860.

In sum, the embodiments of the systems and methods disclosed herein provide effective and efficient mechanism for evaluation of sponsorship proposals, management of sponsorship program and measurement of the performance of the sponsorship program. The system provides means for objective-based proposal evaluation, subjective proposal evaluation and financial proposal evaluation. The system also facilitates collection and storage of information about execution of the sponsorship program. The system also provides tools for cost/value measurement of the performance of the sponsorship program as well as return-on-objective and subjective measurements of the effectiveness of the sponsorship program. Those skilled in the art will realize that there are other advantages of the disclosed embodiments of the invention.

The foregoing description and accompanying figures illustrate exemplary embodiments of the present inventions in such a way to enable those skilled in the art to make and use the inventions and various embodiments. Those skilled in the art will understand the foregoing description and accompanying figures explain the principles of the present inventions and their practical application, and they can modify the inventions and embodiments to suit their needs while still following the same principles. Those skilled in the art will also understand the specific terms, nomenclature and formulae in the foregoing description are used to allow those skilled in the art to fully understand the present inventions and do not limit the present inventions to what is described by those terms, nomenclature and formulae. Thus, those skilled in the art will appreciate the foregoing disclosure is not intended to be exhaustive or to limit the inventions to the precise forms disclosed, and those skilled in the art recognize that many modifications and variations are possible in view of the above teachings.

1. A system for sponsorship management comprising:
a portal application server operative to collect and validate information on a sponsorship proposal from a property user;
a database server operative to store sponsorship proposal information in one or more data stores; and
a desktop application server comprising one or more software modules operative to facilitate one or more of a sponsor user role-based access, objective and subjective evaluation of a sponsorship proposal, routing an evaluated sponsorship proposal based on its state, management of sponsorship assets in connection with a sponsorship program, and measurement of sponsorship program performance and objective and subjective evaluation of sponsorship program results.

2. The system of claim 1, wherein the desktop application server further comprises a web application framework that facilitates execution of the one or more software modules.

3. The system of claim 2, wherein the web application framework includes a database interface that facilitates data communication between the one or more software modules and the database server.

4. The system of claim 2, wherein the web application framework includes a user authentication module that facilitates the role-based sponsor user access to the sponsorship proposal information.

5. The system of claim 4, wherein under control of the user authentication module the ro1e-based access to the sponsorship proposal information provides different access permissions to the sponsorship proposal information for different sponsor users with different roles.

6. The system of claim 1, wherein the desktop application server comprises an objectives alignment module operative to determine the degree of fitness of a sponsorship proposal with one or more strategic sponsorship objectives specified by a sponsor user.

7. The system of claim 6, wherein the strategic sponsorship objectives comprise one or more of marketing objectives, target demographic objectives and brand attribute objectives.

8. The system of claim 6, wherein the strategic sponsorship objectives are stored in the database server.

9. The system of claim 1, wherein the desktop application server includes a scoring and evaluation module for the objective evaluation of a sponsorship proposal which involves comparing the information collected on such sponsorship proposal against one or more sponsor user-specified sponsorship criteria.

10. The system of claim 9, wherein the one or more sponsor user-specified sponsorship criteria comprise one or more of a type of the sponsorship property, fitness of the sponsorship property and the sponsor's brand, and the geographic market exposure of the sponsorship.

11. The system of claim 10, wherein the scoring and evaluation module is operative to automatically reject a sponsorship proposal if such sponsorship proposal does not meet one or more sponsor user-specified sponsorship criteria.

12. The system of claim 8, wherein to facilitate the subjective evaluation of a sponsorship proposal, the scoring and evaluation module provides to the sponsor user one or more questionnaires that solicit the sponsor user's opinion about such sponsorship proposal.

13. The system of claim 12, wherein the scoring and evaluation module is operative to provide to the sponsor user one or more sample answers to one or more questions provided in such questionnaires, wherein one or more provided sample answers have numeric values assigned thereto.

14. The system of claim 13, wherein the scoring and evaluation module is operative to compute a subjective evaluation score based on the numeric values of answers chosen by the sponsor user in response to the one or more provided questions.

15. The system of claim 1, wherein the desktop application server comprises a financial valuation module operative to calculate a monetary value of one or more sponsorship assets.

16. The system of claim 1, wherein the desktop application server comprises a leverage and activation module operative to collect information about execution of a sponsorship program associated with a sponsorship proposal.

17. The system of claim 1, wherein information about execution of a sponsorship program comprises one or more of media buys, signage, deployment of on-site personnel and consumer survey results.

18. The system of claim 1, wherein the desktop application server comprises a media evaluation module operative to collect information about appearances of a sponssor brand in one or more electronic media sources.

19. The system of claim 18, wherein the media evaluation module is operative to compute a value of appearance of the sponsor brand in electronic media sources.

20. The system of claim 1, wherein the desktop application server comprises a performance measurement module operative to perform cost/value measurement of an executed sponsorship program based on the information provided by one or more of a leverage and activation module and a media evaluation module.

21. The system of claim 1, wherein the desktop application server comprises a performance measurement module operative to facilitate a subjective performance measurement of an executed sponsorship.

22. The system of claim 21, wherein to facilitate subjective performance measurement, the performance measurement module provides the sponsor user with one or more questionnaires that solicit sponsor user's opinion about effectiveness of an executed sponsorship program.

23. The system of claim 1, wherein the desktop application server comprises a performance measurement module operative to perform a return-on-objective (ROO) measurement of an executed sponsorship.

24. A method for sponsorship management, the method being computer implemented and comprising:
collecting and validating information on a sponsorship proposal from a property user;
performing objective evaluation of such sponsorship proposal based on its collected and validated information and, if it meets objective criteria, performing subjetive evaluation of such sponsorship proposal in order to determine its state which includes one rejected and approved, wherein the subjective evaluation is performed by a sponser user having role-based access rights to the collected and validated information;
routing such proposed sponsership to a folder based on its state, wherein, if approved, execution of a sponsership program associated with such proposed sponsership can commence; and
measuring performance of an executed sponsorship program and evaluating its results objectively and subjectively.

25. The method of claim 24, wherein collecting the information on such sponsership proposal comprises automated solicitation of the information from the property user via one or more sponsership proposal questionnaires that are accessible via a portal application server.

26. The method of claim 24, comprising storing the collected and validated information in a data store.

27. The method of claim 24, wherein determining the role-based access rights of at least one sponsor user responsible for evaluating a sponsorship proposal comprises authentication of the at least one sponsor user.

28. The method of claim 27, wherein the authentication is based on one or more of a sponsor user's job title, department and office location.

29. The method of claim 24, wherein the objective evaluation is performed by evaluating the collected and validated information against one or more sponsorship criteria specified by a sponsor user.

30. The method of claim 29, wherein the one or more sponsorship criteria one or more of a type of sponsored property, fitness of the sponsored property and a sponsor's brand, and a geographic market exposure of the a sponsorship.

31. The method of claim 29, further comprising automatically rejecting a sponsorship proposal if it does not meet one or more sponsorship criteria.

32. The method of claim 24, wherein the subjective evaluation comprises;
providing to one or more sponsor users one or more questions to solicit an opinion about the sponsorship proposal;
providing one or more sample answers to the one or more questions, wherein one or more answers have numeric values assigned thereto; and
computing a subjective evaluation score based on the numeric values of answers chosen by one or more of the sponsor users in response to the one or more questions.

33. The method of claim 24, wherein the objective evaluation of a sponsorship proposal includes performing an objectives alignment on the sponsorship proposal to determine the degree of fitness of the sponsorship proposal with one or more strategic sponsorship objectives specified by a sponsor user.

34. The method of claim 33, wherein the strategic sponsorship objectives comprise one or more of marketing objectives, target demographic objectives and brand attribute objectives.

35. The method of claim 33, wherein the objectives alignment comprises:
defining one or more weighted relations between one or more strategic sponsorship objectives and one or more questions in a sponsorship proposal questionnaire;
mapping one or more items of the sponsorship proposal information solicited from the property user in response to the questions in the sponsership proposal questionnaires with the one or more strategic sponsorship objectives based on the weighted relations thereof; and
computing an objectives alignment score that indicates the percentage match between items of the sponsorship proposal information and the one or more strategic sponsorship objectives.

36. The method of claim 24, further comprising performing financial valuation of the sponsorship proposal by computing monetary values of one or more sponsorship assets.

37. The method of claim 24, wherein collecting information about execution of the sponsorship comprises collecting leverage and activation information, wherein the leverage and activation information comprises information about one or more of media buys, signage, deployment of on-site personnel and consumer survey results.

38. The method of claim 24, wherein collecting information about execution of the sponsorship comprises collecting information about appearance of the sponsor brand in one or more electronic media sources.

39. The method of claim 38, further comprising computing monetary values of appearance of the sponsor brand in one or more electronic media sources.

40. The method of claim 24, wherein measuring performance of the executed sponsorship comprises measuring cost/value ratio of the sponsorship based on information concerning results of the sponsorship program.

41. The method of claim 24, wherein measuring performance of the executed sponsorship comprises facilitating subjective measurement of its performance.

42. The method of claim 41, wherein the subjective performance measurement comprises providing one or more questionnaires that solicit a sponser user's opinion about performance of an executed sponsership program and collecting sponser user's responses to the one or more questionnaires.

43. The method of claim 24, wherein measuring performance of the executed sponsorship program comprises measuring its return-on-objective (ROO).

44. The method of claim 43, wherein the ROO measurement comprises;
selecting a strategic sponsorship objective for measuring the ROO;
determining one or more specific tactical objectives that relate to the selected strategic sponsorship objective;
determining one or more tactical objective measures for each tactical objective based on sponsorship program execution information;
computing a percent of success scores for the one or more specific tactical objectives based on the corresponding tactical objective measures;
app1ying one or more weighting coefficients to the computed percentile scores based on the degree of importance of the given tactical objective with respect to other tactical objectives; and
combining the weighted percentile scores to produce the ROO.

45. The method of claim 44, Wherein one or more specific tactical objectives are selected from the collected and validated information on the sponsorship proposal.

46. A method for sponsorship management, the method being computer implemented and comprising:
collecting information about an executed sponsorship program, the collected information comprising information about one or more of leverage, logistics and media exposure of the sponsorship;
performing an objectives-based measurement of the sponsorship program performance;
performing a subjective measurement of the sponsorship program performance; and
computing a cost/value ratio of the sponsorship program based on the information about leverage, logistics and media exposure of the sponsorship program.

47. The method of claim 46, wherein performing the objectives-based measurement of the sponsorship program performance comprises measuring a return-on-objective (ROO) of the executed sponsorship program.

48. The method of claim 47, wherein the ROO measurement comprises;
selecting a strategic sponsorship objective for measuring the ROO;
determining one or more specific tactical objectives that relate to the selected strategic sponsorship objective;
determining one or more tactical objective measures for each tactical objective based on sponsorship program execution information;
computing a percent of success scores for the one or more specific tactical objectives based on the corresponding tactical objective measures;
applying one or more weighting coefficients to the computed percentile scores based on the degree of importance of the given tactical objective with respect to other tactical objectives; and
combining the weighted percentile scores to produce the ROO of the selected strategic sponsorship objective.

49. The method of claim 46, wherein the subjective measurement of the sponsorship comprises providing a plurality of questions soliciting a sponsor user's opinion about sponsorship performance and evaluating sponsor user responses to the questions.

50. The method of claim 49, wherein providing the sponsor user with a plurality of questions further comprises providing the sponsor user with one or more answers to one or more provided questions.

51. The method of claim 50, wherein an answer to a question has a numeric value assigned thereto.

52. The method of claim 49, wherein evaluating sponsor user responses to the provided questions comprises performing a mathematical operation on the numeric values of the answers selected by the sponsor user in response to the provided questions.

53. The method of claim 52, wherein the result of the mathematical operation is a subjective measure of the sponsorship program performance.

54. The method of claim 46, comprising generating a sponsorship program performance report based on the results of objectives-based performance measurement, subjective performance measurement and measurement of the cost/value ratio.

55. A system for managing business proposals and business programs executed between an enterprise and a user, comprising:
a portal application server accessible to a user and operative to collect business proposal submissions from the user; and
a desktop application server operative to objectively and subjectively evaluate submitted business proposals and manage business programs for business proposals that are approved and implemented, wherein the desktop application server includes a web application framework and enterprise extensions, the web application framework being operative to provide role-based access to a particular user associated with an enterprise, organize and display the business proposals based on results of their evaluation and report business proposal approval state and business program performance to the particular user, and the enterprise extensions include one or more of objectives alignment module, performance measurement module, financial valuation module, scoring & evaluation module, leverage and logistics module and media evaluation module.

56. A system for managing business proposals and business programs executed between an enterprise and a user, comprising:
means for collecting and validating information on a business proposal from a user;
means for performing objective evaluation of such business proposal by evaluating its collected and validated information against objective criteria;
means for facilitating subjective evaluation of such business proposal, if it meets objective criteria in the objective evaluation, in order to determine an approval state of the business proposal, wherein the subjective evaluation is performed by a particular user having role-based access rights to the collected and validated information;
means for routing such business proposal to a folder based on its approval state, wherein, if approved, execution of a business program associated with such business proposal can commence; and
means for measuring performance of an executed business program and for evaluating its results, objectively and subjectively.

57. The system as in claim 1, wherein the objective evaluation of one or both of a sponsorship proposal and sponsorship program results is automatic.

58. The method of claim 24, wherein the objective evaluation of one or both of a sponsorship proposal and sponsorship program results is automatic.

59. The method of claim 56, wherein the objective evaluation of one or both of a sponsorship proposal and sponsorship program results is automatic.
